(19) United States
(12) Patent Application Publication
(10) Pub. No.: US 2025/0030874 A1
(43) Pub. Date: Jan. 23, 2025

(54) METHOD FOR CHROMA COMPONENT PREDICTION BASED ON RECONSTRUCTED LUMA INFORMATION

(71) Applicants: HYUNDAI MOTOR COMPANY, SEOUL (KR); KIA CORPORATION, SEOUL (KR); KWANGWOON UNIVERSITY INDUSTRY-ACADEMIC COLLABORATION FOUNDATION, SEOUL (KR)

(72) Inventors: Dong Gyu SIM, Seoul (KR); Joo Hyung BYEON, Seoul (KR); Min Hun LEE, Uijeongbu-si (KR); Jin HEO, Yongin-si (KR); Seung Wook PARK, Yongin-si (KR)

(21) Appl. No.: 18/894,789

(22) Filed: Sep. 24, 2024

Related U.S. Application Data
(63) Continuation of application No. PCT/KR2023/002987, filed on Mar. 3, 2023.

(30) Foreign Application Priority Data
Mar. 24, 2022 (KR) 10-2022-0036596
Mar. 2, 2023 (KR) 10-2023-0027859

(51) Int. Cl. H04N 19/159; H04N 19/176; H04N 19/186

(52) U.S. Cl. CPC H04N 19/159; H04N 19/176; H04N 19/186

(57) ABSTRACT

A method is disclosed for predicting chroma components based on reconstructed luma information. In the disclosed embodiments, to intra-predict the current chroma block, the video decoding device decodes the prediction mode indicator of the current chroma block and checks whether the prediction mode indicator utilizes the Direct Mode_Intra Block Copy mode (DM_IBC mode) for the current chroma block. If the current chroma block utilizes DM_IBC mode, the video decoding device uses the block vector of the previously reconstructed corresponding luma block to generate the prediction block of the current chroma block.

### CROSS-REFERENCE TO RELATED APPLICATIONS

This application is a continuation of International Application No. PCT/KR2023/002987 filed on Mar. 3, 2023, which claims priority to and the benefit of Korean Patent Application No. 10-2022-0036596 filed on Mar. 24, 2022, and Korean Patent Application No. 10-2023-0027859, filed on Mar. 2, 2023, the entire contents of each of which are incorporated herein by reference.

### TECHNICAL FIELD

The present disclosure relates to a method predicting chroma components based on reconstructed luma information.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, as the image size, resolution, and frame rate gradually increase, the amount of data to be encoded also increases. Accordingly, a new compression technique providing higher coding efficiency and an improved image enhancement effect than existing compression techniques is required. In particular, there is a need for techniques for effectively predicting chroma components by using reconstructed luma information.

### SUMMARY

The present disclosure seeks to provide a video coding method and an apparatus that predict chroma blocks efficiently based on prediction information and partition information of previously reconstructed luma blocks for use in a dual-tree technique of providing a luma component and chroma component with separate block partition structures.

At least one aspect of the present disclosure provides a method performed by a video decoding device for intra-predicting a current chroma block. The method includes decoding a prediction mode indicator of the current chroma block. Here, the prediction mode indicator indicates whether a Direct Mode_Intra Block Copy mode (DM_IBC mode) is to be used by the current chroma block. The method also includes checking the prediction mode indicator. When the current chroma block uses the DM_IBC mode, the method further includes generating a prediction block of the current chroma block by using a block vector of a previously reconstructed corresponding luma block.

Another aspect of the present disclosure provides a method performed by a video encoding device for intra-predicting a current chroma block. The method includes generating a first prediction block of the current chroma block by using a Direct Mode_Intra Block Copy mode (DM_IBC mode) that uses a block vector of a previously reconstructed corresponding luma block to generate the first prediction block. The method also includes generating a second prediction block of the current chroma block by using a chroma prediction mode that is other than the DM_IBC mode but a prediction mode for a chroma component. The method also includes determining a prediction mode indicator of the current chroma block based on the first prediction block and the second prediction block in terms of rate-distortion optimization. Here, the prediction mode indicator indicates whether the DM_IBC mode is to be used by the current chroma block. The method also includes encoding the prediction mode indicator.

Yet another aspect of the present disclosure provides a computer-readable recording medium storing a bitstream generated by a video encoding method. The video encoding method includes generating a first prediction block of a current chroma block by using a Direct Mode_Intra Block Copy mode (DM_IBC mode) that uses a block vector of a previously reconstructed corresponding luma block to generate the first prediction block. The video encoding method also includes generating a second prediction block of the current chroma block by using a chroma prediction mode that is other than the DM_IBC mode but a prediction mode for a chroma component. The video encoding method also includes determining a prediction mode indicator of the current chroma block based on the first prediction block and the second prediction block in terms of rate-distortion optimization. Here, the prediction mode indicator indicates whether the DM_IBC mode is to be used by the current chroma block. The video encoding method also includes encoding the prediction mode indicator.

As described above, the present disclosure provides a video coding method and an apparatus that predict chroma blocks efficiently based on prediction information and partition information of previously reconstructed luma blocks for use in a dual-tree technique of providing a luma component and chroma component with separate block partition structures. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a direct mode (DM) application location in a corresponding luma block for the current chroma block.

FIG. 7 is a flowchart illustrating a chroma prediction device according to at least one embodiment of the present disclosure.

FIG. 8 is a diagram illustrating a DM application location in a corresponding luma block for a subblock, according to at least one embodiment of the present disclosure.

FIG. 9 is a diagram illustrating the merging of subblocks, according to at least one embodiment of the present disclosure.

FIG. 10 is a diagram illustrating the merging of subblocks, according to another embodiment of the present disclosure.

FIG. 11 is a diagram illustrating the merging of subblocks, according to another embodiment of the present disclosure.

FIG. 12 is a diagram illustrating the prediction of regions that are not in Intra Block Copy mode (IBC mode), according to at least one embodiment of the present disclosure.

FIG. 13 is a diagram illustrating the prediction of regions that are not in Intra Block Copy mode (IBC mode), according to at least one embodiment of the present disclosure.

FIG. 14 is a diagram illustrating a prediction of a current chroma block utilizing the block vector of the corresponding luma block, according to at least one embodiment of the present disclosure.

FIG. 15 is a diagram illustrating a prediction of a current chroma block based on a region of a prediction mode in a corresponding luma block, according to at least one embodiment of the present disclosure.

FIG. 16 is a diagram illustrating a determination of a transform unit of a chroma block, according to at least one embodiment of the present disclosure.

FIG. 17 is a diagram illustrating the DM_IBC mode application location in a corresponding luma block for the current chroma block.

FIG. 18 is a flowchart of a method performed by a video encoding device for intra-predicting a current chroma block, according to at least one embodiment of the present disclosure.

FIG. 19 is a flowchart of a method performed by a video decoding device for intra-predicting a current chroma block, according to at least one embodiment of the present disclosure.

FIG. 20 is a flowchart of a method performed by the video encoding device for intra-predicting a current chroma block, according to another embodiment of the present disclosure.

FIG. 21 is a flowchart of a method performed by the video decoding device for intra-predicting a current chroma block, according to another embodiment of the present disclosure.

FIG. 22 is a flowchart of a method performed by the video encoding device for intra-predicting a current chroma block, according to yet another embodiment of the present disclosure.

FIG. 23 is a flowchart of a method performed by the video decoding device for intra-predicting a current chroma block, according to yet another embodiment of the present disclosure.

### DETAILED DESCRIPTION

Hereinafter, certain embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

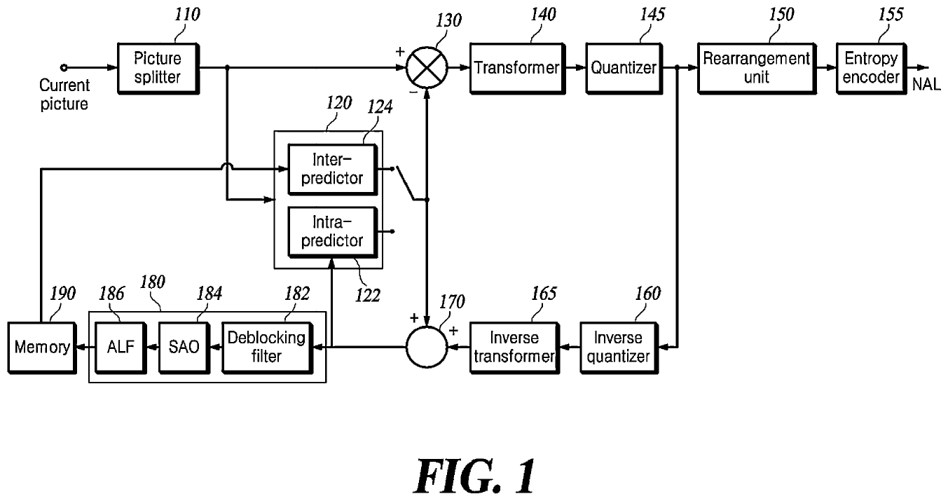

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

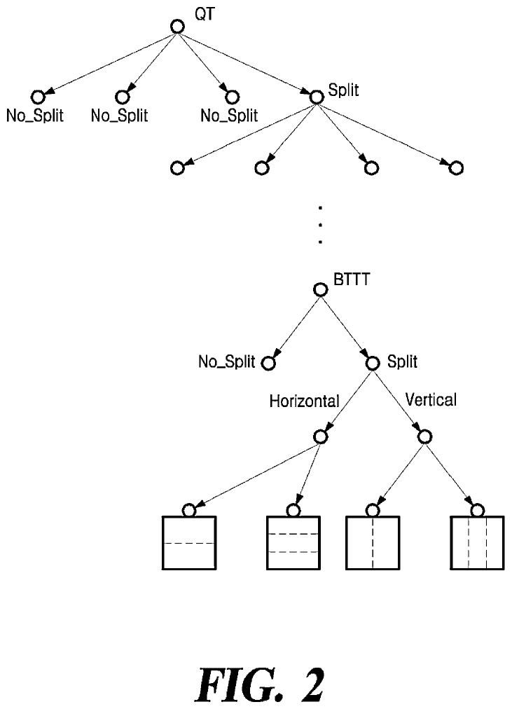

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

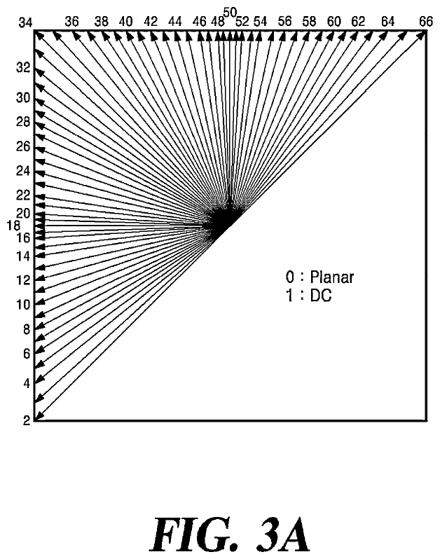

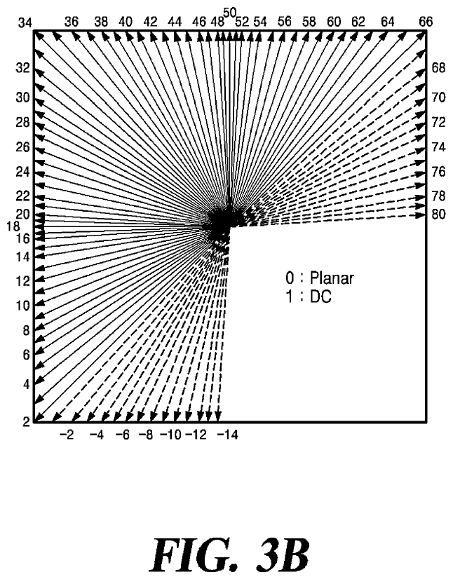

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

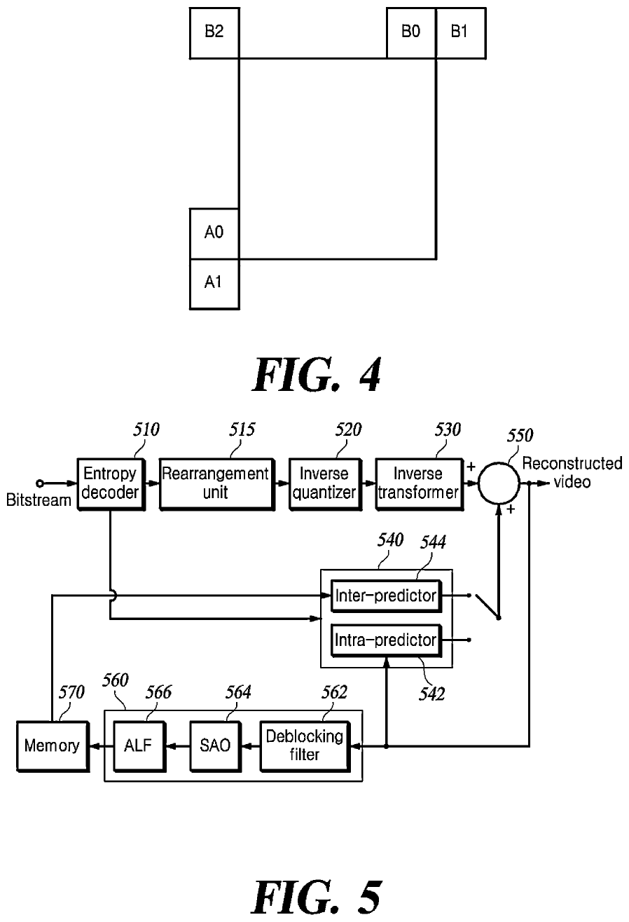

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that predict chroma blocks efficiently based on prediction information and partition information of previously reconstructed luma blocks for use in a dual-tree technique of providing a luma component and chroma component with separate block partition structures.

The following embodiments may be performed by the intra predictor 122 in the video encoding device. The following embodiments may also be performed by the intra predictor 542 in the video decoding device.

The video encoding device in intra-predicting the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the intra-predicting of the current block.

In the following description, the term “target block” may be used interchangeably with the current block or coding unit (CU). The term “target block” may refer to some region of the coding unit.

Further, the value of one flag being true indicates when the flag is set to 1. Additionally, the value of one flag being false indicates when the flag is set to 0.

### I-1. Intra Prediction of Chroma Components

In the VVC (Versatile Video Coding) technique, the intra-prediction mode of the luma block has 65 subdivided directional modes (i.e., 2 to 66), in addition to the non-directional modes (i.e., planar and DC), as illustrated in FIG. 3A. The 65 directional modes, planar and DC, are collectively referred to as 67 IPMs.

Depending on the prediction direction utilized by the luma block, the chroma block may also have a limited usage of the intra prediction of these subdivided directional modes. However, the intra prediction of the chroma block may not always utilize the various directional modes available to the luma block besides the horizontal and vertical directions. To be able to use these different directional modes, the prediction mode of the current chroma block needs to be set to Direct Mode (DM). By setting the prediction mode to DM, the current chroma block may utilize directional modes other than the horizontal and vertical of the luma block.

When a chroma block is encoded, the intra-prediction modes that are most commonly used or defaulted to maintain video quality include planar, DC, vertical, horizontal, and DM. In DM, the intra-prediction mode of the luma block that spatially corresponds to the current chroma block is utilized as the intra-prediction mode of the chroma block.

The video encoding device may signal to the video decoding device whether the intra-prediction mode of the chroma block is DM. In this case, the video encoding device may communicate the DM to the video decoding device in several ways. For example, the video encoding device may indicate whether the intra-prediction mode of the chroma block is DM by setting intra_chroma_pred_mode, which is information for indicating the intra-prediction mode of the chroma block, to a specific value and transmitting intra_chroma_pred_mode to the video decoding device.

If the chroma block is encoded in intra-prediction mode, the video encoding device may set the chroma block's intra-prediction mode of IntraPredModeC according to Table 1.

To distinguish the information, intra_chroma_pred_mode related to the chroma block's intra-prediction mode from IntraPredModeC, the following expresses intra_chroma_pred_mode and IntraPredModeC as chroma intra-prediction mode indicator and chroma intra-prediction mode, respectively.

TABLE 1

| | | | lumaIntraPredMode | | | | |
|---|---|---|---|---|---|---|---|
| | | intra_chro- | | | | | X (0 <= |
| cclm_mode_flag | cclm_mode_idx | ma_pred_mode | 0 | 50 | 18 | 1 | X <= 66) |
| 0 | — | 0 | 66 | 0 | 0 | 0 | 0 |
| 0 | — | 1 | 50 | 66 | 50 | 50 | 50 |
| 0 | — | 2 | 18 | 18 | 66 | 18 | 18 |
| 0 | — | 3 | 1 | 1 | 1 | 66 | 1 |
| 0 | — | 4 | 0 | 50 | 18 | 1 | X |
| 1 | 0 | — | 81 | 81 | 81 | 81 | 81 |
| 1 | 1 | — | 82 | 82 | 82 | 82 | 82 |
| 1 | 2 | — | 83 | 83 | 83 | 83 | 83 |

Here, lumaIntraPredMode is the intra-prediction mode of the luma block corresponding to the current chroma block (hereinafter, ‘luma intra-prediction mode’). The lumaIntraPredMode represents one of the prediction modes illustrated in FIG. 3A. For example, in Table 1, the equation that lumaIntraPredMode=0 refers to the planar prediction mode and the equation that lumaIntraPredMode=1 refers to the DC prediction mode. Cases with lumaIntraPredMode of 18, 50, and 66 indicate directional modes, referred to as horizontal, vertical, and VDIA, respectively. On the other hand, cases that intra_chroma_pred_mode=0, 1, 2, and 3 refer to planar, vertical, horizontal, and DC prediction modes, respectively. The case that intra_chroma_pred_mode=4 is DM, where the value of IntraPredModeC, the chroma intra-prediction mode, is set equal to the value of lumaIntraPredMode.

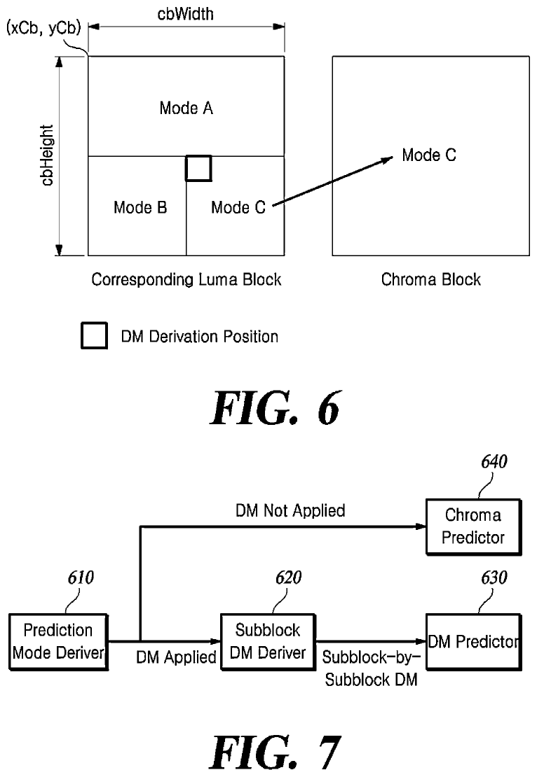

On the other hand, if a dual-tree is applied that gives separate block partition structures to the luma and chroma components, multiple luma blocks may correspond to a single chroma block. Therefore, the intra-prediction mode of the chroma block according to the DM may be determined as the intra-prediction mode of the center position of the corresponding luma block, as shown in the example of FIG. 6 and Equation 1.

$$IntraPredModeC = IntraPredModeY [ xCb + c b W i dth / 2 ] [ y C b + c b H e i ght / 2 ] \qquad [ Equation 1 ]$$

Here, (xCb, yCb) represents the position of the top-left pixel of the corresponding luma block, and cbWidth and cbHeight represent the width and height of the corresponding luma block. In the example of FIG. 6, the corresponding luma block includes multiple luma blocks with prediction modes A, B, and C. In the example of FIG. 6, the format of the chroma blocks is 4:4:4.

Further, in the application of the dual-tree, if the prediction mode of the luma block at the corresponding position is a matrix-based prediction mode (MIP), the prediction mode of the chroma block according to DM is mapped to planar mode, and if the prediction mode of the luma block is a palette mode and Intra Block Copy (IBC) mode, the prediction mode of the chroma block according to DM is mapped to DC mode.

Hereinafter, the DM prediction as described above is referred to as ‘regular DM prediction’ and is distinguished from the ‘subblock-level DM prediction’ described below. It is also assumed that the corresponding luma block utilized for DM prediction is reconstructed before the current chroma block.

Hereinafter, a subblock-level DM prediction method according to the present disclosure and a chroma block prediction method using an IBC block vector of a previously reconstructed luma block are be described centering on a video decoding device. These methods may be similarly performed by the video encoding device.

### I-2. Intra Block Copy (IBC)

The IBC performs an intra prediction of the current block by copying a reference block in the same frame by using the block vector to generate a prediction block of the current block.

The video encoding device performs block matching to derive an optimal block vector. Here, the block vector represents a displacement from the current block to the reference block. To improve coding efficiency, the video encoding device may not transmit the block vector as it is but separate the block vector into a block vector predictor (BVP) and a block vector difference (BVD), and encode and transmit the BVP and the BVD to the video decoding device.

Hereinafter, the spatial resolution of the BVD is assumed to be the same as that of the block vector.

### II. Subblock-Level DM Prediction Method

FIG. 7 is a flowchart illustrating a chroma prediction device according to at least one embodiment of the present disclosure.

The intra predictor 542 in the video decoding device may include a chroma prediction device, such as the one illustrated in FIG. 7. Such a chroma prediction device may be applied to a dual-tree. The chroma prediction device may include all or part of a prediction mode deriver 610, a subblock DM deriver 620, a DM predictor 630, and a chroma predictor 640.

The prediction mode deriver 610 decodes from the bitstream a prediction mode indicator (e.g., intra_chroma_pred_mode) of the current chroma block. Using the prediction mode indicator, the prediction mode deriver 610 determines if the prediction mode of the current chroma block is DM (Direct Mode). Depending on whether the prediction mode of the current chroma block is DM, operations of the subblock DM deriver 620 or the chroma predictor 640 may be performed.

If the prediction mode of the current chroma block is DM, the subblock DM deriver 620 first determines whether to utilize subblock-level DM prediction for the current chroma block.

In one example, the subblock DM deriver 620 may decode a subblock DM flag. Here, the subblock DM flag indicates whether to utilize the subblock DM prediction or the regular DM prediction for the current chroma block. If the subblock DM flag is true, the video decoding device utilizes the subblock DM prediction. On the other hand, if the subblock DM flag is false, the video decoding device may use regular DM prediction.

As another example, the subblock DM deriver 620 may implicitly determine whether to utilize a subblock-level DM prediction based on the size of the current chroma block. For example, if (i) the number of pixels in the current chroma block (width×height) is less than a certain threshold, (ii) both width and height are less than a certain threshold, or (iii) at least one of the width and height is less than a certain threshold, then a subblock-level DM prediction may not be applied.

If the subblock-level DM prediction is not utilized, the DM predictor 630 generates a prediction block of the current chroma block based on the regular DM prediction.

On the contrary, if subblock-level DM prediction is utilized, the subblock DM deriver 620 derives subblock-level DM as follows.

The subblock DM deriver 620 partitions the current chroma block into subblocks, and derives a prediction mode for each subblock by using the prediction mode of the previously reconstructed corresponding luma block. The subblock partitioning may be performed in n×m increments determined by an agreement between the video encoding device and the video decoding device, or may be performed based on the size and/or aspect ratio of the current chroma block.

When subblocks are generated in n×m increments, n, m may be of size 2^{a}, 2^{b} (a,b≥2), respectively. In some embodiments, all chroma blocks may be partitioned into subblocks of the same size. Alternatively, the magnitudes of n and m may vary depending on the size of the current chroma block. In this case, the subblocks may be generated according to the following embodiments.

<Embodiment 1> If the current chroma block has a width≥8, a height≥8, and a width×height>64, the current chroma block may be partitioned into 8×8 subblocks. Otherwise, the current chroma block may be partitioned into 4×4 subblocks.

<Embodiment 2> The current chroma block may be partitioned into subblocks having sizes n=max(k, width/2), m=max(k, height/2), where k=4, 8, or 16.

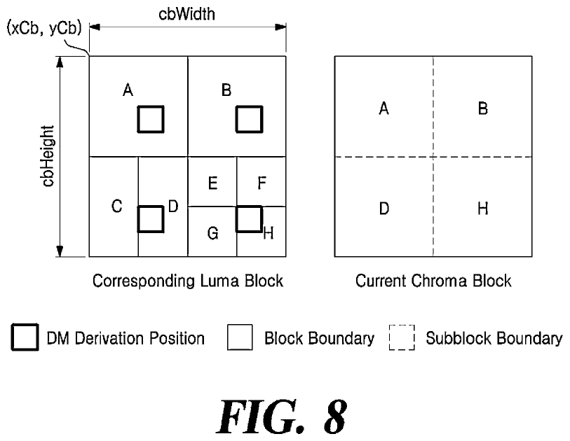

For each partitioned subblock, the subblock DM deriver 620 may derive the prediction mode of a luma block corresponding to a specific position in each subblock (hereinafter referred to as a ‘corresponding luma block’) as the prediction mode of the subblock. The specific position may vary depending on the embodiment, such as top left, center, bottom right, and the like. As shown in one example of FIG. 8, at the center position in the subblock, the prediction mode of the corresponding luma block may be derived to be the prediction mode of the subblock. In the example of FIG. 8, the format of the chroma block is 4:4:4.

The DM predictor 630 generates the prediction block of the current chroma block based on the subblock-level DM. The DM predictor 630 may generate the prediction block of the current chroma block by performing a prediction per subblock based on the subblocks partitioned by the subblock DM deriver 620 and the prediction mode derived per subblock. At this time, the subblocks may be reconstructed by sequentially predicting the partitioned subblocks in the z-scan order and performing entropy reconstruction/inverse quantization/inverse transform of the residual signal. At this time, for each subblock, the DM predictor 630 may perform a prediction by using previously reconstructed subblocks as reference samples.

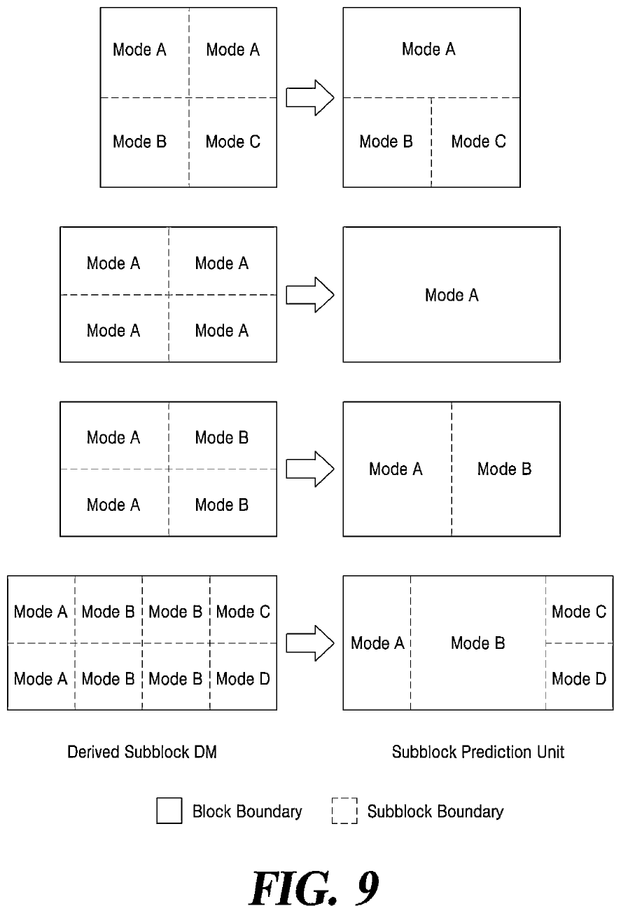

In some embodiments, the subblocks partitioned by the subblock DM deriver 620 may be block merged based on the derived prediction mode of each subblock. As illustrated in FIG. 9, block merging is to merge the corresponding subblocks to generate a single subblock if the derived prediction mode per subblock is the same as the neighboring subblocks. The DM predictor 630 may then perform a prediction on the merged subblock.

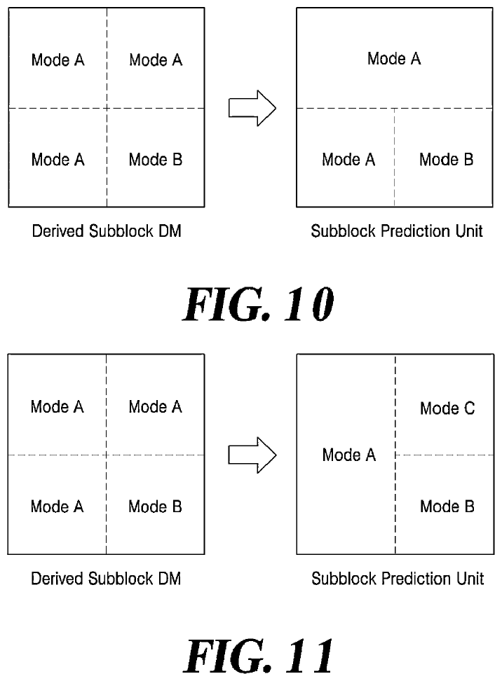

As an example, if subblocks in an L-shape have the same prediction mode, such as in the examples of FIG. 10 or FIG. 11, the corresponding subblocks may not be merged. Alternatively, the subblocks may be merged in a horizontal or vertical direction. In this case, the merging in the horizontal or vertical direction may be defined by an agreement between the video encoding device and the video decoding device or may be implicitly determined by the aspect ratio of the current chroma block. In the example of FIG. 10, if the prediction mode of the subblocks in the L-shape is the same, the subblocks are merged in the horizontal direction. On the other hand, in the example of FIG. 11, if the subblocks in the L-shape have the same prediction mode, the subblocks are merged in the vertical direction.

In some embodiments, if the prediction mode determined by the subblock DM deriver 620 is an IBC mode, the DM predictor 630 may convert the IBC mode to a non-directional mode (DC or planar mode) according to an agreement between the video encoding device and the video decoding device, and then may perform the prediction according to the converted mode. Alternatively, the DM predictor 630 may use the block vector of the luma block corresponding to the subblock to perform the chroma IBC prediction. In this case, the block vector of the subblock may be scaled according to the chroma format of the current picture.

On the other hand, if the subblocks generated by the subblock DM deriver 620 all have the same prediction mode, the DM predictor 630 may perform a regular DM prediction rather than a subblock-level DM prediction. This case may be the same as when all subblocks are block merged into one. In this case, the same prediction mode of the subblocks may be utilized as the prediction mode of the current chroma block.

On the other hand, if the prediction mode of the current chroma block is not DM, the chroma predictor 640 may generate a chroma prediction mode based on the prediction mode indicator (e.g., if intra_chroma_pred_mode is 0 to 3 in Table 1), and then may generate a prediction block of the current chroma block based on the generated chroma prediction mode.

### III. Chroma Block Prediction Method Using Block Vector of Previously Reconstructed Luma Block

As described above, if subblock-level DM prediction is not utilized in the dual-tree partition structure, the DM predictor 630 may generate a prediction block of the current chroma block based on a regular DM prediction. In this case, if the prediction mode of the previously reconstructed corresponding luma block corresponding to the current chroma block is in IBC mode, the DM predictor 630 may use the block vector (BV) of the corresponding luma block to predict the current chroma block.

To this end, the prediction mode deriver 610 parses the prediction mode of the current chroma block. When the parsed prediction mode is DM, the DM predictor 630 obtains the prediction mode of the previously reconstructed corresponding luma block and then checks the prediction mode of the corresponding luma block. When the prediction mode of the corresponding luma block is IBC mode, the DM predictor 630 uses the block vector of the corresponding luma block to generate the prediction block of the current chroma block. On the other hand, if the prediction mode of the corresponding luma block is not IBC mode, the prediction block of the current chroma block may be generated according to the regular DM prediction.

If the prediction mode of the corresponding luma block is IBC mode, the DM predictor 630 derives the block vector of the luma block as the block vector of the current chroma block without additional signaling/parsing. At this time, the derived block vector may be scaled according to the chroma format of the current picture.

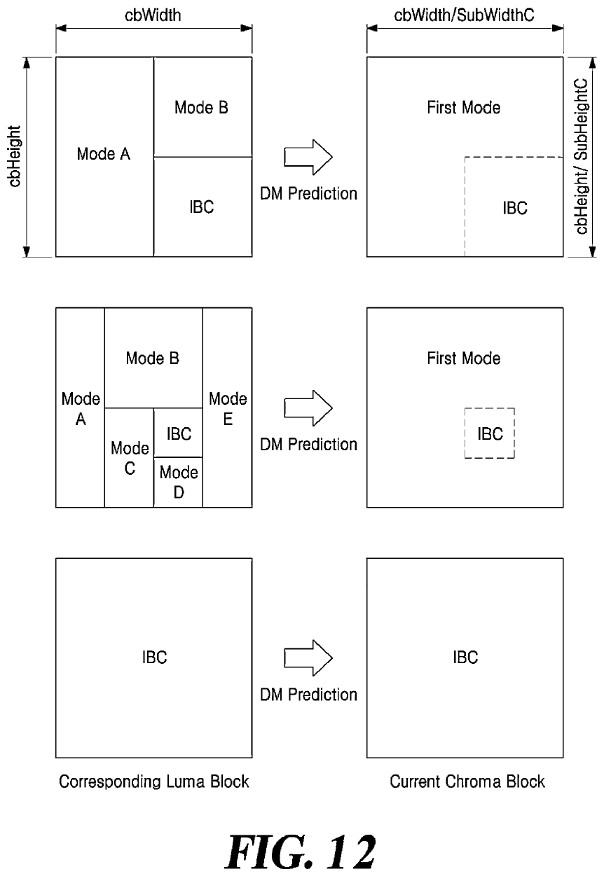

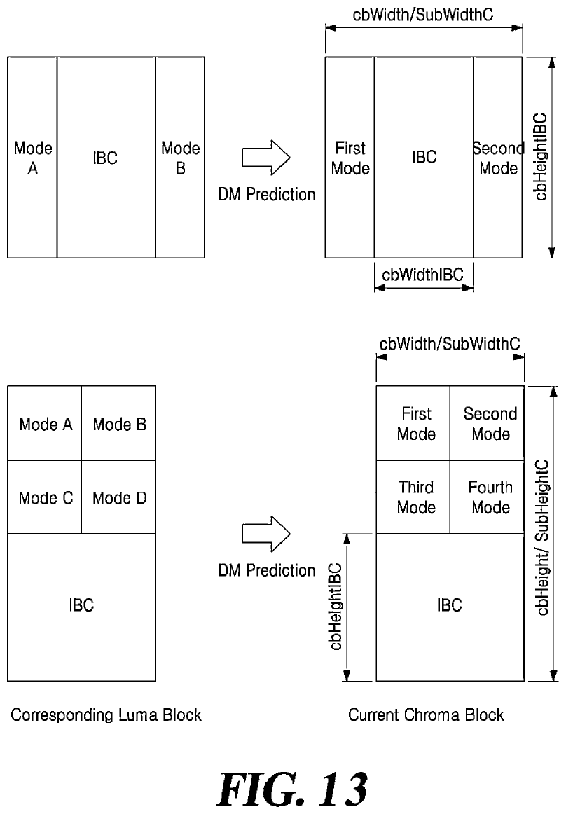

When multiple luma blocks correspond to the current chroma block, as in the example of FIG. 12, the DM predictor 630 may perform the prediction by using a single mode for the remaining regions except the IBC region. Alternatively, if the chroma block subject to the IBC prediction has a width of cbWidthIBC and a height of cbHeightIBC, and where cbWidthIBC=cb Width/SubWidthC or cbHeightIBC=cbHeight/SubHeightC, the DM predictor 630 may perform the prediction by using each prediction mode for the regions other than in the IBC mode, as shown in the example of FIG. 13. On the other hand, for the regions of the chroma block other than the region corresponding to the IBC mode of the luma component, the prediction mode may be determined based on an agreement between the video encoding device and the video decoding device, or the prediction mode of the corresponding luma block. In the example of FIG. 12 or FIG. 13, SubWidthC and SubHeightC are defined as shown in Table 2 according to the chroma format of the current picture.

TABLE 2

| Chroma format | SubWidthC | SubHeightC |
|---|---|---|
| 4:2:0 | 2 | 2 |
| 4:2:2 | 2 | 1 |
| 4:4:4 | 1 | 1 |

As another example, the DM predictor 630 may perform a prediction by using a non-directional mode for a region other than the IBC region or may perform a prediction by using a prediction mode of a luma block corresponding to a specific position. In this case, the non-directional mode may be determined as DC, planar mode, and the like according to an agreement between the video encoding device and the video decoding device.

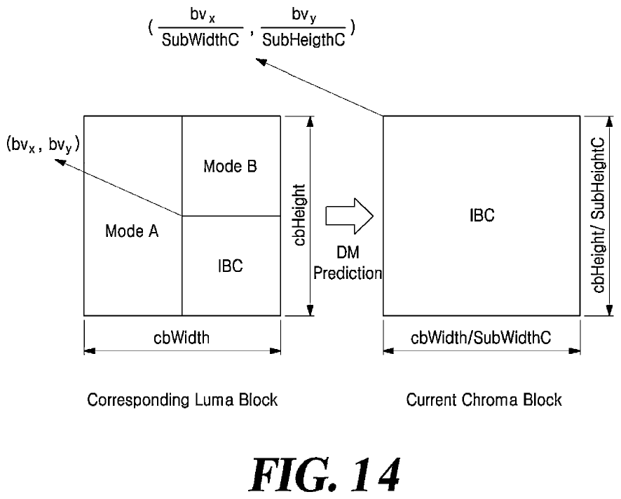

As yet another example, when the IBC mode is selected as DM for the current chroma block, the DM predictor 630 may predict the entire current chroma block in IBC mode by using the block vector (bvₓ, bv_{y}) of the corresponding luma block, as shown in the example of FIG. 14. At this time, the block vector used for chroma prediction may be scaled according to the chroma format of the current picture, as shown in Equation 2.

$$( \frac{b {v}_{x}}{SubWidthC} , \frac{b {v}_{y}}{SubHeightC} ) \qquad [ Equation 2 ]$$

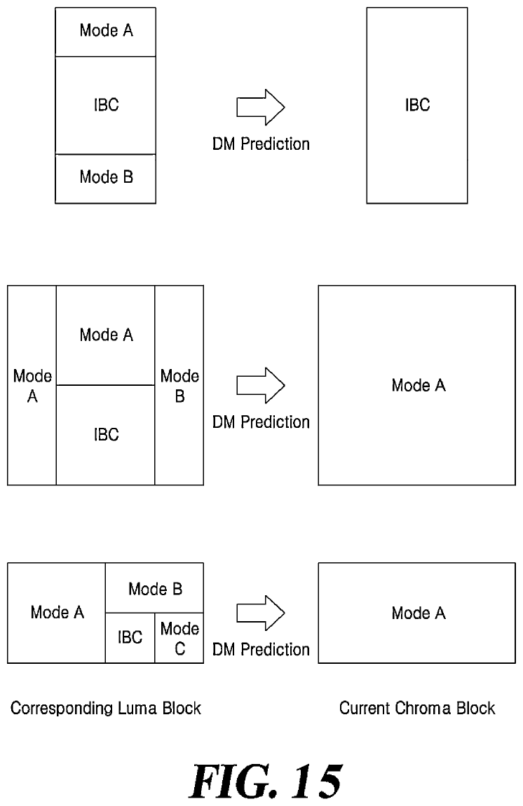

As yet another example, if the IBC mode is selected as DM for the current chroma block, the DM predictor 630 may calculate the size of the region of each prediction mode in the corresponding luma block, and select the mode with the largest size of the region occupied by the corresponding luma block. Then, as illustrated in FIG. 15, the DM predictor 630 may perform a prediction by using the selected mode as the prediction mode of the current chroma block. If there are multiple modes with the largest size of the area occupied by the chroma block, the prediction mode may be determined based on an agreement between the video encoding device and the video decoding device.

On the other hand, concerning the transform of the prediction block, this embodiment may perform entropy decoding, inverse quantization, and inverse transform of the residual signal by counting the chroma block as one transform unit (TU). Alternatively, the transform unit may be determined by the size of the block predicted in the IBC mode. When the transform unit is determined based on the size of the block predicted in the IBC mode, and when the chroma block subject to the IBC prediction has a width of cb WidthIBC and a height of cbHeightIBC and where cbWidthIBC=cbWidth/SubWidthC or cbHeightIBC-cbHeight/SubHeightC, the reconstruction of the current chroma block may be performed by determining the block predicted in the non-directional mode or the mode of the corresponding luma block, and the block predicted in the IBC mode, as the transform unit, respectively. In this case, Sub WidthC and SubHeightC are defined according to Table 2 as described above.

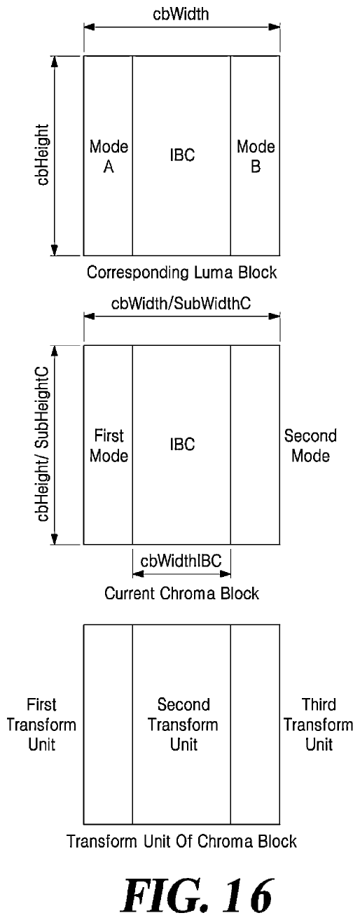

As in the example of FIG. 16, where cbHeightIBC=cbHeight/SubHeightC, the transform unit of the chroma block may be determined. Here, the non-directional mode or the mode region of the corresponding luma block, and the IBC mode region may be determined in each transform unit, and for each transform unit, the residual signal may be entropy decoded, inversely quantized, and inversely transformed. At this time, the non-directional mode or the mode region of the corresponding luma block, and the IBC mode region may be transformed and inversely transformed by using different transform kernels. The components of the vertical and horizontal directions of the transform kernel may be implicitly determined according to an agreement between the video encoding device and the video decoding device based on the size of the transform unit (block).

As another example, if the mode region of the non-directional mode or the corresponding luma block, and the IBC mode region is partitioned into a plurality of transform units and the transform is performed, each block is reconstructed according to the z-scan order, and the mode region of the non-directional mode or the corresponding luma block may be predicted by using the reference sample values reconstructed in the previous order.

On the other hand, in some embodiments, a DM_IBC (Direct Mode_Intra Block Copy) mode may be added as a chroma prediction mode. Some embodiments handle a case, in place of DM prediction, where the prediction mode of the corresponding luma block is an IBC mode in a new mode that is the DM_IBC mode. To this end, for example, the prediction mode indicator decoded by the prediction mode deriver 610 may further specify the DM_IBC mode. Then, if the prediction mode of the current chroma block is DM_IBC mode, the DM predictor 630 may perform an IBC prediction of the current chroma block by using the block vector of the corresponding luma block.

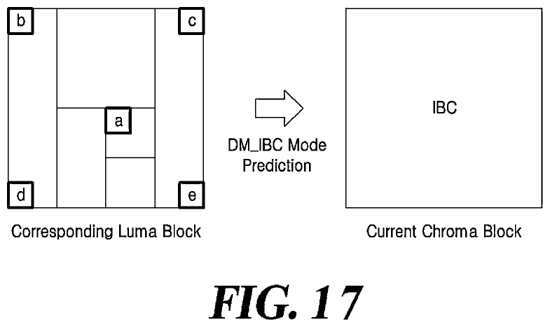

In one example, if the corresponding luma block includes multiple luma blocks, the DM predictor 630 may determine a predetermined natural number N of positions in the corresponding luma block based on an agreement between the video encoding device and the video decoding device, as shown in the example of FIG. 17. Upon detecting a block predicted in IBC mode, the DM predictor 630 may perform an IBC prediction of the current chroma block based on the block vector of the detected corresponding luma block.

The DM predictor 630 may first locate N positions in a predetermined order and then may use the block vector of the first luma block predicted in IBC mode to perform the IBC prediction of the current chroma block.

As another example, if a natural number M of blocks is predicted at all or some of the predetermined N positions (wherein M is less than or equal to N) in the IBC mode by using different block vectors, the DM predictor 630 may perform template matching for each block vector based on the reference sample area of the current chroma block to determine the optimal block vector. The DM predictor 630 may perform IBC prediction of the current chroma block based on the optimal block vector.

As yet another example, if the natural number M of blocks is predicted at all or some of the predetermined N positions (wherein M is less than or equal to N) in the IBC mode by using different block vectors, the DM predictor 630 may select, from the M blocks, a block having the largest area in the corresponding luma block. Then, the DM predictor 630 may perform an IBC prediction of the current chroma block based on the block vector of the selected block.

On the other hand, if the prediction mode of the current chroma block is not DM_IBC, the chroma predictor 640 may generate a chroma prediction mode based on the prediction mode indicator (e.g., if intra_chroma_pred_mode is 0 to 3 in Table 1), and then may generate a prediction block of the current chroma block based on the generated chroma prediction mode.

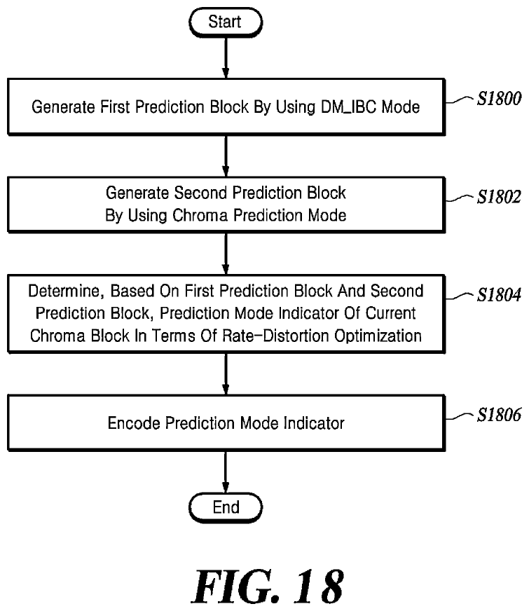

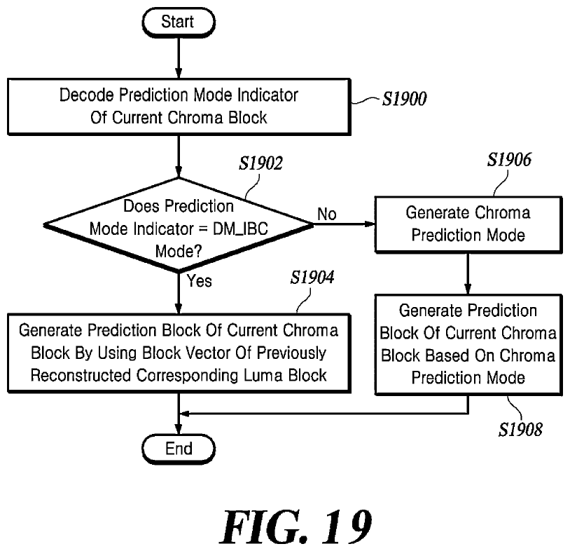

Hereinafter, methods of predicting a current chroma block based on a DM_IBC mode are be described by using the examples of FIGS. 18 to 19.

FIG. 18 is a flowchart of a method performed by the video encoding device for intra-predicting a current chroma block, according to at least one embodiment of the present disclosure.

The video encoding device generates a first prediction block by using the DM_IBC mode for the current chroma block (S1800). Here, the DM_IBC mode generates the first prediction block by using the block vector of the previously reconstructed corresponding luma block.

The video encoding device generates a second prediction block by using a chroma prediction mode for the current chroma block (S1802). Here, the chroma prediction mode is the prediction mode for the chroma component, not the DM_IBC mode. For example, the chroma prediction mode may be one of the prediction modes corresponding to Table 1 where intra_chroma_pred_mode is 0 to 3.

The video encoding device determines, based on the first prediction block and the second prediction block, a prediction mode indicator of the current chroma block in terms of rate-distortion optimization (S1804).

Here, the prediction mode indicator indicates whether to utilize the DM_IBC mode for the current chroma block. If the first prediction block is more optimal in terms of rate distortion, the video encoding device may set the prediction mode indicator to the DM_IBC mode. On the other hand, if the second prediction block is more optimal in terms of rate distortion, the video encoding device may set the prediction mode indicator to prediction mode, not DM_IBC mode.

The video encoding device encodes the prediction mode indicator (S1806).

FIG. 19 is a flowchart of a method performed by the video decoding device for intra-predicting a current chroma block, according to at least one embodiment of the present disclosure.

The video decoding device decodes the prediction mode indicator of the current chroma block (S1900). Here, the prediction mode indicator indicates whether the DM_IBC mode is utilized for the current chroma block.

The video decoding device checks the prediction mode indicator (S1902).

If DM_IBC mode is utilized (Yes in S1902), the video decoding device generates the prediction block of the current chroma block by using the block vector of the previously reconstructed corresponding luma block (S1904).

On the other hand, if the DM_IBC mode is not utilized (No in S1902), the video decoding device generates a chroma prediction mode by using the prediction mode indicator (S1906) and then generates a prediction block of the current chroma block based on the generated chroma prediction mode (S1908).

Here, the chroma prediction mode is a prediction mode for the chroma component, not the DM_IBC mode. For example, the chroma prediction mode may be one of the prediction modes corresponding to Table 1 where intra_chroma_pred_mode is 0 to 3.

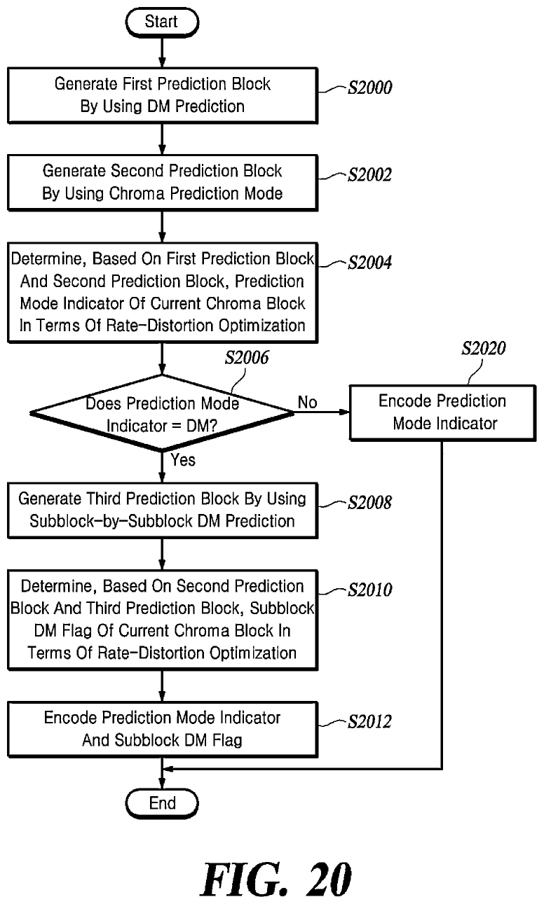

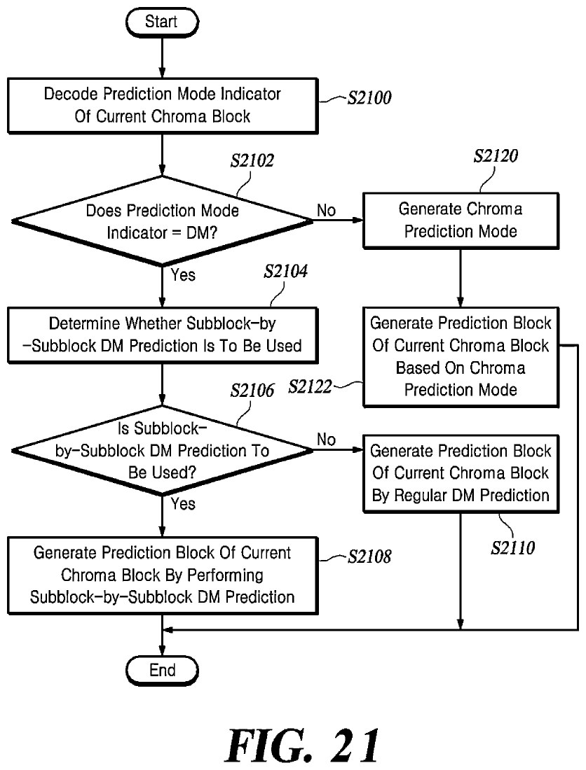

Hereinafter, using the examples of FIGS. 20 and 21, methods of predicting a current chroma block based on a subblock-level DM are described.

FIG. 20 is a flowchart of a method performed by the video encoding device for intra-predicting a current chroma block, according to another embodiment of the present disclosure.

The video encoding device generates a first prediction block by using DM prediction for the current chroma block (S2000). Here, the DM prediction generates the first prediction block by using the previously reconstructed estimate of the corresponding luma block.

The video encoding device generates a second prediction block by using a chroma prediction mode for the current chroma block (S2002). Here, the chroma prediction mode is the prediction mode for the chroma component, not DM. For example, the chroma prediction mode may be one of the prediction modes corresponding to Table 1 where intra_chroma_pred_mode is 0 to 3.

Based on the first prediction block and the second prediction block, the video encoding device determines a prediction mode indicator of the current chroma block in terms of optimizing the rate-distortion (S2004).

Here, the prediction mode indicator indicates whether DM is utilized for the current chroma block. If the first prediction block is more optimal in terms of rate distortion, the video encoding device may set the prediction mode indicator to DM. On the other hand, if the second prediction block is more optimal in terms of rate distortion, the video encoding device may set the prediction mode indicator to prediction mode, not DM.

The video encoding device checks the prediction mode indicator (S2006).

If DM is used (Yes in S2006), the video encoding device performs the following steps (S2008 to S2012).

The video encoding device performs a subblock-level DM prediction to generate a third prediction block (S2008).

The video encoding device may generate the third prediction block by partitioning the current chroma block into subblocks, deriving a prediction mode of each subblock by using the prediction mode of the previously reconstructed corresponding luma block, and performing a prediction of each subblock by using the prediction mode of each subblock.

The video encoding device determines a subblock DM flag in terms of rate-distortion optimization based on the second prediction block and the third prediction block (S2010). Here, the subblock DM flag indicates whether the subblock-level DM prediction is utilized for the current chroma block. For example, if the third prediction block is more optimal in terms of rate distortion, the video encoding device may set the subblock DM flag to true. On the other hand, if the second prediction block is more optimal in terms of rate distortion, the video encoding device may set the subblock DM flag to false.

The video encoding device encodes the prediction mode indicator and the subblock DM flag (S2012).

On the other hand, the video encoding device may implicitly determine whether to utilize subblock-level DM prediction based on the size of the current chroma block. In such a case, the video encoding device may omit setting and encoding the subblock DM flag.

If DM is not used (No in S2006), the video encoding device encodes the prediction mode indicator (S2020).

FIG. 21 is a flowchart of a method performed by the video decoding device for intra-predicting a current chroma block, according to another embodiment of the present disclosure.

The video decoding device decodes the prediction mode indicator of the current chroma block (S2100). Here, the prediction mode indicator indicates whether DM is utilized for the current chroma block.

The video decoding device checks the prediction mode indicator (S2102).

If DM is utilized (Yes in S2102), the video decoding device determines whether to utilize subblock-level DM prediction for the current chroma block (S2104).

In one example, the video decoding device may decode a subblock DM flag. Here, the subblock DM flag indicates whether to utilize a subblock-level DM prediction for the current chroma block. If the subblock DM flag is true, the video decoding device utilizes the subblock-level DM prediction. On the other hand, if the subblock DM flag is false, the video decoding device may utilize the regular DM prediction.

As another example, the video decoding device may implicitly determine whether to utilize the subblock-level DM prediction based on the size of the current chroma block.

The video decoding device determines whether to utilize the subblock-level DM prediction for the current chroma block (S2106).

If subblock-level DM prediction is utilized (Yes in S2106), the video decoding device performs the subblock-level DM prediction to generate a prediction block of the current chroma block (S2108).

The video decoding device may generate the prediction block of the current chroma block by partitioning the current chroma block into subblocks, using the prediction mode of the previously reconstructed corresponding luma block to derive the prediction mode of each subblock, and then performing a prediction of each subblock by using the prediction mode of each subblock.

If the subblock-level DM prediction is not utilized (No in S2106), the video decoding device generates the prediction block of the current chroma block according to the regular DM prediction (S2110).

If DM is not utilized (No in S2102), the video decoding device generates a chroma prediction mode by using the prediction mode indicator (S2120) and then generates a prediction block of the current chroma block based on the generated chroma prediction mode (S2122).

Here, the chroma prediction mode is a prediction mode for the chroma component, not the DM. For example, the chroma prediction mode may be one of the prediction modes corresponding to Table 1 where intra_chroma_pred_mode is 0 to 3.

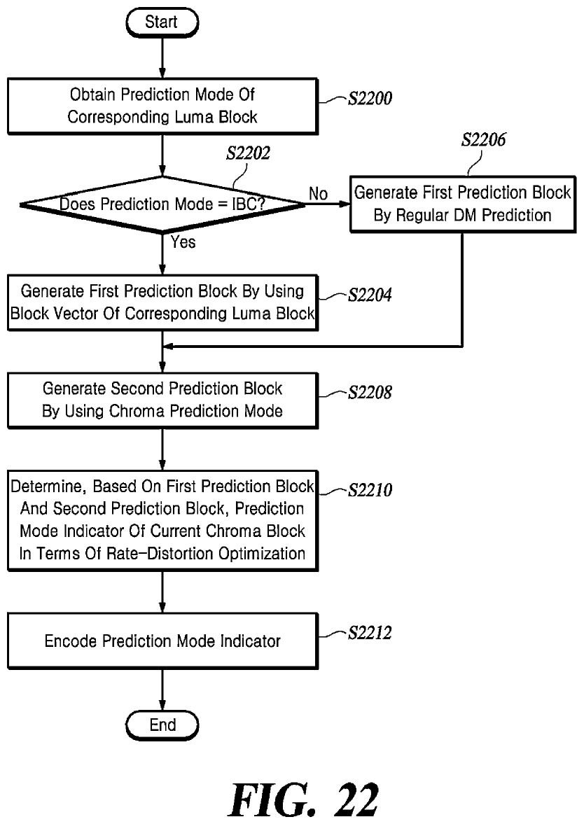

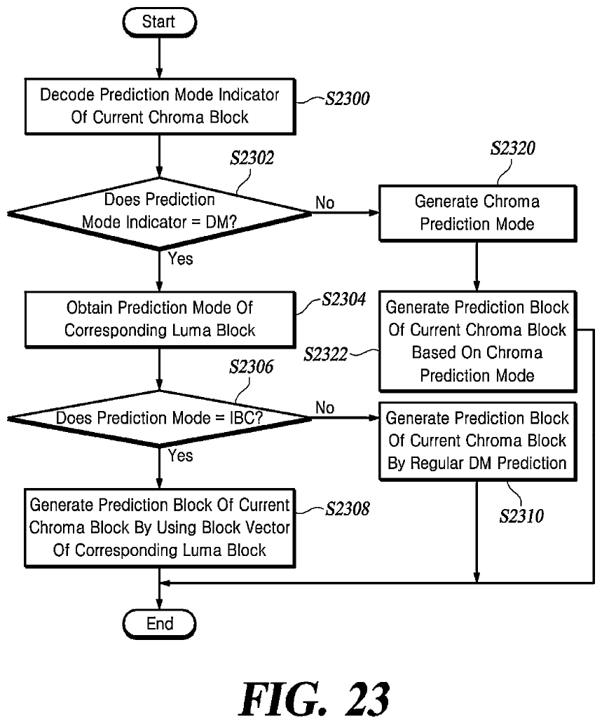

Using the examples of FIGS. 22 and 23, methods are described for predicting a current chroma block by using a block vector of a previously reconstructed luma block.

FIG. 22 is a flowchart of a method performed by the video encoding device for intra-predicting a current chroma block, according to yet another embodiment of the present disclosure.

The video encoding device obtains, for the current chroma block, the prediction mode of the previously reconstructed corresponding luma block (S2200).

The video encoding device determines whether the prediction mode of the corresponding luma block is an IBC mode (S2202).

If the prediction mode of the corresponding luma block is IBC mode (Yes in S2202), the video decoding device generates, for the current chroma block, a first prediction block by using the block vector of the corresponding luma block (S2204).

If the prediction mode of the corresponding luma block is not IBC mode (No in S2202), the video decoding device generates the first prediction block according to the regular DM prediction for the current chroma block (S2206).

The video encoding device generates a second prediction block by using the chroma prediction mode for the current chroma block (S2208). Here, the chroma prediction mode is the prediction mode for the chroma component, not DM. For example, the chroma prediction mode may be one of the prediction modes corresponding to Table 1 where intra_chroma_pred_mode is 0 to 3.

The video encoding device determines, based on the first prediction block and the second prediction block, a prediction mode indicator of the current chroma block in terms of optimizing the rate-distortion (S2210).

Here, the prediction mode indicator indicates whether DM is utilized for the current chroma block. If the first prediction block is more optimal in terms of rate distortion, the video encoding device may set the prediction mode indicator to DM. On the other hand, if the second prediction block is more optimal in terms of rate distortion, the video encoding device may set the prediction mode indicator to prediction mode, not DM.

The video encoding device encodes the prediction mode indicator (S2212).

FIG. 23 is a flowchart of a method performed by the video decoding device for intra-predicting a current chroma block, according to yet another embodiment of the present disclosure.

The video decoding device decodes the prediction mode indicator of the current chroma block (S2300). Here, the prediction mode indicator indicates whether DM is utilized for the current chroma block.

The video decoding device checks the prediction mode indicator (S2302).

If DM is used (Yes in S2302), the video decoding device obtains the prediction mode of the corresponding luma block previously reconstructed for the current chroma block (S2304)

The video decoding device determines whether the prediction mode of the corresponding luma block is IBC mode (S2306).

If the prediction mode of the corresponding luma block is IBC mode (Yes in S2306), the video decoding device generates the prediction block of the current chroma block by using the block vector of the corresponding luma block (S2308).

If the prediction mode of the corresponding luma block is not IBC mode (No in S2306), the video decoding device generates the prediction block of the current chroma block according to the regular DM prediction (S2310).

If DM is not utilized (No in S2302), the video decoding device generates a chroma prediction mode by using the prediction mode indicator (S2320) and then generates a prediction block of the current chroma block based on the generated chroma prediction mode (S2322).

Here, the chroma prediction mode is a prediction mode for the chroma component, not DM. For example, the chroma prediction mode may be one of the prediction modes corresponding to Table 1 where intra_chroma_pred_mode is 0 to 3.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
155: entropy encoder
510: entropy decoder
542: intra predictor
610: prediction mode deriver
620: subblock DM deriver
630: DM predictor
640: chroma predictor

What is claimed is:

1. A method performed by a video decoding device for intra-predicting a current chroma block, the method comprising:
decoding a prediction mode indicator of the current chroma block, wherein the prediction mode indicator indicates whether a Direct Mode_Intra Block Copy mode (DM_IBC mode) is to be used for the current chroma block; and
checking the prediction mode indicator,
wherein when the current chroma block uses the DM_IBC mode, generating a prediction block of the current chroma block by using a block vector of a previously reconstructed corresponding luma block.

2. The method of claim 1, further comprising, when the current chroma block does not use the DM_IBC mode:
generating a chroma prediction mode by using the prediction mode indicator; and
generating a prediction block of the current chroma block based on the chroma prediction mode.

3. The method of claim 1, wherein generating the prediction block comprises, when the corresponding luma block comprises a plurality of luma blocks:
responsive to a predicted luma block being retrieved in an Intra Block Copy mode (IBC mode) by checking a predetermined natural number N positions in the corresponding luma block, generating the prediction block of the current chroma block based on a block vector of a retrieved luma block.

4. The method of claim 3, wherein generating the prediction block comprises:
retrieving a first luma block predicted in the IBC mode by checking the predetermined natural number N positions in a predetermined order, and then generating the prediction block of the current chroma block based on a block vector of the retrieved luma block.

5. The method of claim 3, wherein generating the prediction block comprises:
when a natural number M of blocks is predicted at all or some of the predetermined natural number N positions (wherein M is less than or equal to N) in the IBC mode by using different block vectors, performing template matching for each block vector based on a reference sample region of the current chroma block to determine an optimal block vector, and then generating the prediction block of the current chroma block based on the optimal block vector.

6. The method of claim 3, wherein generating the prediction block comprises:
when a natural number M of blocks is predicted at all or some of the predetermined natural number N positions (wherein M is less than or equal to N) in the IBC mode by using different block vectors, selecting, from the M blocks, a block having a largest area in the corresponding luma block, and then generating the prediction block of the current chroma block based on a block vector of the selected block.

7. A method performed by a video encoding device for intra-predicting a current chroma block, the method comprising:
generating a first prediction block of the current chroma block by using a Direct Mode_Intra Block Copy mode (DM_IBC mode) that uses a block vector of a previously reconstructed corresponding luma block to generate the first prediction block;
generating a second prediction block of the current chroma block by using a chroma prediction mode that is a prediction mode for a chroma component;
determining a prediction mode indicator of the current chroma block based on the first prediction block and the second prediction block in terms of rate-distortion optimization, the prediction mode indicator indicating whether the DM_IBC mode is to be used for the current chroma block; and
encoding the prediction mode indicator.

8. The method of claim 7, wherein generating the first prediction block comprises, when the corresponding luma block comprises a plurality of luma blocks:
responsive to a predicted luma block being retrieved in an Intra Block Copy mode (IBC mode) by checking a predetermined natural number N positions in the corresponding luma block, generating the first prediction block based on a block vector of the retrieved luma block.

9. The method of claim 8, wherein generating the first prediction block comprises:
retrieving a first luma block predicted in the IBC mode by checking the predetermined natural number N positions in a predetermined order, and then generating the first prediction block based on a block vector of the retrieved luma block.

10. The method of claim 8, wherein generating the first prediction block comprises:
when a natural number M of blocks is predicted at all or some of the predetermined natural number N positions (wherein M is less than or equal to N) in the IBC mode by using different block vectors, performing template matching for each block vector based on a reference sample region of the current chroma block to determine an optimal block vector, and then generating the first prediction block based on the optimal block vector.

11. The method of claim 8, wherein generating the first prediction block comprises:
when a natural number M of blocks is predicted at all or some of the predetermined natural number N positions (wherein M is less than or equal to N) in the IBC mode by using different block vectors, selecting, from the M blocks, a block having a largest area in the corresponding luma block, and then generating the first prediction block based on a block vector of the selected block.

12. A computer-readable recording medium storing a bitstream generated by a video encoding method, the video encoding method comprising:
generating a first prediction block of a current chroma block by using a Direct Mode_Intra Block Copy mode (DM_IBC mode) that uses a block vector of a previously reconstructed corresponding luma block to generate the first prediction block;
generating a second prediction block of the current chroma block by using a chroma prediction mode that is a prediction mode for a chroma component;
determining a prediction mode indicator of the current chroma block based on the first prediction block and the second prediction block in terms of rate-distortion optimization, the prediction mode indicator indicating whether the DM_IBC mode is to be used for the current chroma block; and
encoding the prediction mode indicator.
